(19) United States
(12) Patent Application Publication
(10) Pub. No.: US 2026/0186237 A1
(43) Pub. Date: Jul. 2, 2026

(54) HEAD-MOUNTED ELECTRONIC DEVICE

(71) Applicant: Beijing Zitiao Network Technology Co., Ltd., Beijing (CN)

(72) Inventor: Wei JIA, Beijing (CN)

(21) Appl. No.: 18/727,944

(22) PCT Filed: Jan. 6, 2023
(86) PCT No.: PCT/CN2023/070941

§ 371 Date: Jul. 10, 2024

(30) Foreign Application Priority Data
Jan. 13, 2022 (CN) 202210038740.9

(51) Int. Cl. G02B 7/12

(52) U.S. Cl. CPC G02B 7/12

(57) ABSTRACT

A head-mounted electronic device, comprising a housing in which a controller is provided; an obtaining unit for obtaining human eye positions, the obtaining unit being provided in the housing, and connected to the controller; left and right display units each comprising a lens and a supporting member, the lens being fixed to the supporting member; a driving apparatus comprising a driving member and two moving members, the driving member cooperating with the two moving members to drive the two moving members to move, the two moving members cooperating with the two supporting members respectively to drive the two supporting members to move away from or towards each other, the driving member being connected to the controller, and the controller controlling the driving member to drive the two moving members to move according to information obtained by the obtaining unit to adjust a distance between the two lenses.

### CROSS-REFERENCE OF RELATED APPLICATIONS

This application claims the priority of a Chinese patent application submitted on Jan. 13, 2022, with application No. 202210038740.9 and entitled “HEAD-MOUNTED ELECTRONIC DEVICE”. All contents of this application are incorporated in the present application by reference.

### FIELD

The present application relates to the technical field of virtual reality, and particularly, to a head-mounted electronic device.

### BACKGROUND

Virtual reality (VR) technology is a computer-generated simulation that can create a virtual world for users to experience. Virtual reality technology uses a computer to generate a simulated environment that users can observe by wearing a VR device in the eye.

In existing VR devices, the simulated environment is created based on a fixed interpupillary distance, which does not account for individual user differences. This requires manual adjustment by users, resulting in a suboptimal user experience.

### SUMMARY

The present application aims to solve at least one of the technical problems existing in the prior art. For this purpose, the present application provides a head-mounted electronic device which can automatically adjust the distance between two lenses according to the user's pupillary distance, thereby improving user experience.

A head-mounted electronic device according to an embodiment of a first aspect of the present application, comprising: a housing in which a controller is provided; an obtaining unit for obtaining human eye positions, the obtaining unit being provided in the housing, and the obtaining unit being connected to the controller; a left display unit and a right display unit, each of the left display unit and the right display unit comprising a lens and a supporting member, the lens being fixed to the supporting member; a driving apparatus comprising a driving member and two moving members, the driving member cooperating with the two moving members to drive the two moving members to move, the two moving members cooperating with the two supporting members respectively to drive the two supporting members to move away from or towards each other, the driving member being connected to the controller, and the controller controlling the driving member to drive the two moving members to move according to information obtained by the obtaining unit to adjust a distance between the two lenses.

The head-mounted electronic device according to embodiments of the present application can automatically adjust the distance between the two lenses according to the user's pupillary distance, thereby improving user experience.

In addition, the head-mounted electronic device according to above embodiments of the present application may also have the following additional technical features.

According to some embodiments of the present application, the obtaining unit is a camera.

According to some embodiments of the present application, the moving member and the supporting member are detachably mated.

According to some embodiments of the present application, each of the display units further comprises a barrel and a screen, each of the lenses is provided on the barrel, the barrel is fixed on the supporting member, and the screen is provided between each of the barrels and the corresponding supporting member.

According to some embodiments of the present application, the head-mounted electronic device further comprising a limiting apparatus cooperating with the moving member and the housing to limit a moving range of the moving member.

According to some embodiments of the present application, the driving member is a driving motor, the driving apparatus further comprises a lead screw, the driving motor cooperates with the lead screw to drive the lead screw to rotate, the lead screw is provided with double-helical external threads, and the two moving members cooperate with the threads of the lead screw respectively; the head-mounted electronic device further comprises a limiting member for limiting rotational freedom of the moving member.

In some embodiments, the head-mounted electronic device further comprises a fixing member fixed to the housing, and the driving member being fixed to the fixing member.

In some examples, the limiting member comprises a guide shaft fixed to the fixing member, each of the supporting members is provided with a mating hole, the guide shaft passes through the mating hole and the mating hole movably cooperates with the guide shaft.

In some examples, the head-mounted electronic device further comprises a limiting apparatus comprising a bypass channel provided on the fixing member and a matching protrusion provided on the supporting member, the mating hole being provided within the mating protrusion, the mating protrusion movably cooperating with the bypass channel, and a length of the bypass channel defining a moving range of the mating protrusion to define a moving range of the moving member.

In some embodiments, the fixing member is provided with a moving channel thereon, the limiting member comprises a sliding protrusion provided on the supporting member, and the sliding protrusion movably cooperates with an inner wall of the moving channel.

In some examples, the supporting member is provided with a buckle member thereon, the buckle member protrudes out of the moving channel and hooks to a wall surface of the fixing member.

In some embodiments, a rotation axis of the driving motor coincides with a rotation axis of the lead screw.

In some embodiments, the driving apparatus further comprises a reducer, an input end of the reducer is connected to the driving motor, and an output end of the reducer is connected to the lead screw.

The additional aspects and advantages of the present application will be given in part in the following description, which will become apparent from the following description, or will be learned from the practice of the present application.

### BRIEF DESCRIPTION OF THE DRAWINGS

The above and/or additional aspects and advantages of the present application will become apparent and easily understood from the description of embodiments in conjunction with the following drawings, wherein:

FIG. 1 is a schematic diagram of the structure of a head-mounted electronic device according to an embodiment of the present application.

FIG. 2 is a front view of a head-mounted electronic device according to an embodiment of the present application.

FIG. 3 is a sectional view of A-A in FIG. 2.

FIG. 4 is an enlarged view at B in FIG. 3.

FIG. 5 is a rear view of a head-mounted electronic device according to an embodiment of the present application.

FIG. 6 is an enlarged view at C in FIG. 5.

FIG. 7 is an enlarged view at D in FIG. 5.

### APPENDED DRAWING REFERENCE SIGNS

Head-mounted electronic device 1; Housing 100;
Obtaining unit 200;
Left display unit 301; Right display unit 302; Supporting member 310; Mating hole 311: Buckle member 312; Lens 320; Barrel 330; Screen 340;
Driving apparatus 400; Driving member 410; Moving member 420; First moving member 421; Second moving member 422; Lead screw 430;
Guide shaft 510; Sliding protrusion 520; Fixing member 600; Moving channel 610; Limiting apparatus 700; Mating protrusion 710; Bypass channel 720.

### DETAILED DESCRIPTION

Embodiments of the present application are described in detail below, examples of which are shown in the accompanying drawings, wherein the same or similar reference signs throughout represent the same or similar elements or elements having the same or similar functions. Embodiments described below by reference to the accompanying drawings are exemplary and are intended only to explain the present application and are not to be construed as limiting the present application.

The head-mounted electronic device 1 according to embodiments of the present application is described below with reference to the accompanying drawings.

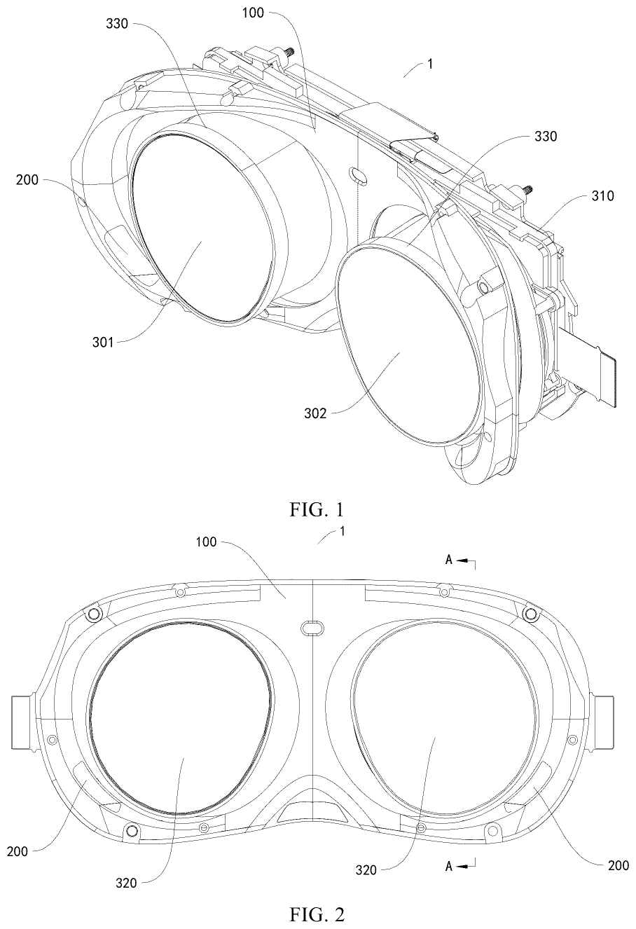

As shown in FIGS. 1-7, the head-mounted electronic device 1 according to embodiments of the present application comprises a housing 100, an obtaining unit 200, a left display unit 301, a right display unit 302, and a driving apparatus 400.

The housing 100 is provided with a controller therein. The obtaining unit 200 is provided in the housing 100 and is connected to the controller in the housing 100, and the obtaining unit 200 can obtain a human eye position and transmit the obtained information about the human eye to the controller.

Each of the left display unit 301 and the right display unit 302 includes a lens 320 and a supporting member 310. The lens 320 is fixed to the supporting member 310. The driving apparatus 400 includes a driving member 410 and two moving members 420. The driving member 410 cooperates with the two moving members 420 to drive the two moving members 420 to move, and the driving member 410 is capable of driving the two moving members 420 to move away from or towards each other to adjust a distance between the two moving members 420. The two moving members 420 cooperate with the two supporting members 310 so as to drive the two supporting members 310 to move away from or towards each other when the two moving members 420 move away from or towards each other, so as to drive the left display unit 301 and the right display unit 302 to move away from or towards each other, so as to adjust the distance between the left display unit 301 and the right display unit 302.

Specifically, the driving member 410 is connected to a controller, and the controller controls the driving member 410 to drive the two moving members 420 to move according to the information obtained by the obtaining unit 200. The two moving members 420 may drive the lenses 320 to move away from or towards each other by driving the supporting member 310, so as to adjust the distance between the two lenses 320 according to the human eye positions obtained by the obtaining unit 200, so that the distance between the two lenses 320 may be automatically adjusted according to the human eye positions of a user when the user uses the head-mounted electronic device 1, thereby improving user experience.

In some embodiments, the head-mounted electronic device 1 is capable of generating a simulated environment, and users can observe the simulated environment generated by the head-mounted electronic device 1 through the lens 320. The housing 100 is provided with two obtaining units 200 to obtain positions of two eyes of a user, respectively. The two obtaining units 200 transmit the obtained positions thereof to the controller. The controller may calculate a distance between the two pupils of the user, i.e. the pupillary distance, according to the information transmitted by the two obtaining units 200. The controller controls the driving member 410 to drive the moving members 420 to move according to the pupillary distance. The moving members 420 drive the two lenses 320 to move away from or towards each other through the supporting member 310, so as to adjust the distance between the two lenses 320, so that the distance between the two lenses 320 is matched with the pupillary distance calculated by the controller, so that the user can more clearly observe the simulated environment generated by the head-mounted electronic device 1.

Therefore, the head-mounted electronic device 1 according to embodiments of the present application can automatically adjust the distance between the two lenses 320 according to the user's pupillary distance, thereby improving user experience.

The head-mounted electronic device 1 according to a specific embodiment of the present application is described below with reference to the accompanying drawings.

In some specific embodiments of the present application, as shown in FIGS. 1-7, the head-mounted electronic device 1 according to embodiments of the present application comprises a housing 100, an obtaining unit 200, a left display unit 301, a right display unit 302, and a driving apparatus 400.

According to some embodiments of the present application, the obtaining unit 200 serves as a camera to photograph human eyes to obtain positions of the human eyes.

The camera can capture positions of the human eyes for multiple times to accurately obtain the information of the human eyes and transmit the correct positions of the human eyes to the controller.

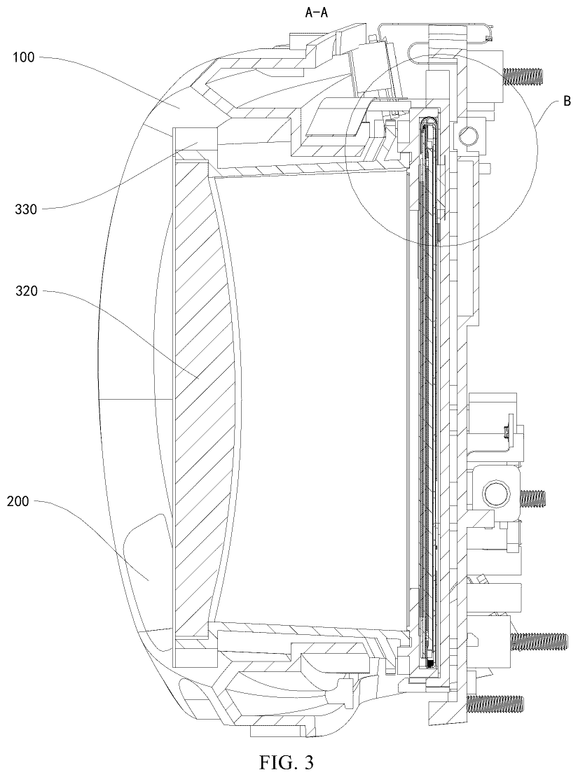

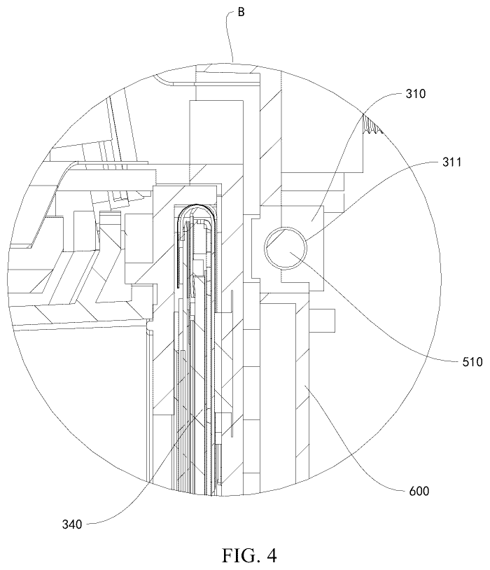

In some embodiments, as shown in FIGS. 2 and 3, in order to accurately photograph the positions of the human eyes, the housing 100 is provided with one camera on each side in the lengthwise direction thereof. When a user wears the head-mounted electronic device 1, the obtaining units 200 are located below the human eyes and are disposed outside the human eyes to clearly photograph the human eyes and provide the controller with the position information of the human eyes.

According to some embodiments of the present application, the moving member 420 and the supporting member 310 are detachably mated so that the relative positions of the moving member 420 and the supporting member 310 can be adjusted by users. In some examples of the present application, the moving member 420 and the supporting member 310 are detachably fitted by screws.

Specifically, the lenses 320 are fixed to the supporting member 310. Detachable fit of the moving member 420 and the supporting member 310 facilitates users to adjust the relative positions of the moving member 420 and the supporting member 310 to adjust the relative positions of the moving member 420 and the lens 320 so that both of the moving members 420 can accurately control the movement of the corresponding lenses 320, so that when the driving member 410 drives the two moving members 420 to move, the two moving members 420 can more accurately control the back or opposite movement of the two lenses 320 to precisely adjust the distance between the two lenses 320.

Furthermore, the detachable fit of the moving member 420 and the supporting member 310 also facilitates users to remove the supporting members 310 and the lenses 320 from the housing 100, thereby facilitating users to clean or replace the lenses 320.

According to some embodiments of the present application, the display unit further comprises a barrel 330 and a screen 340. Each lens 320 is disposed on the barrel 330 which is fixed to the supporting member 310. The screen 340 is provided between each barrel 330 and a corresponding support member 310. The barrel 330 is capable of supporting the lens 320 and the corresponding screen 340 so as to define the position of the screen 340 so that a user can view the contents on the screen 340 through the lens 320.

The screen 340 may be LCD, OLED, MiniLED, MicroLED and other displays.

Specifically, the lens 320 is fixed to one end of the barrel 330, the screen 340 is fixed to the other end of the barrel 330 to space apart by a distance from the lens 320. The supporting member 310 is fixed to the other end of the barrel 330. When the driving member 410 drives the moving member 420 to move, the moving member 420 drives the screen 340, the barrel 330 and the lens 320 to move through the supporting member 310, so that the two barrels 330, the two lenses 320 and the two screens 340 move away from or towards each other.

In some embodiments, the barrel 330 is formed as a cylinder, and the projection of the lens 320 toward the barrel 330 is rounded to mount the lens 320 on one end of the barrel 330 so that users can view the contents on the screen 340 within the barrel 330 through the lens 320.

The screen 340 is mounted on the other end of the barrel 330, and the area of the screen 340 for displaying contents may be formed into a circular shape, adapted to the barrel 330, so that users can view all the contents on the screen 340 through the lens 320.

In addition, the barrel 330 may be configured as a telescoping barrel 330, and the distance between the lens 320 and the screen 340 may be adjusted to adjust the distance between the human eye and the screen 340, so that both myopia and hyperopia users can clearly see the contents on the screen 340. According to some embodiments of the present application, the head-mounted electronic device 1 further comprises a limiting apparatus 700 which respectively cooperates with the moving member 420 and the housing 100 to limit the moving range of the moving member 420 so as to ensure that the driving member 410 can smoothly drive the moving members 420 to move away from or towards each other, while avoiding too large or too small distance between the two moving members 420, which affects users' use.

According to some embodiments of the present application, the driving member 410 is a driving motor, and the driving apparatus 400 further comprises a lead screw 430. The driving motor cooperates with the lead screw 430 to drive the lead screw 430 to rotate, the lead screw 430 is provided with double-helical external threads, the two moving members 420 cooperate with the threads of the lead screw 430 respectively. The head-mounted electronic device 1 is also provided with a limiting member for limiting the rotational freedom of the moving member 420, preventing the two moving members 420 from rotating with the lead screw 430, so that the two moving members 420 can be driven to move when the lead screw 430 rotates.

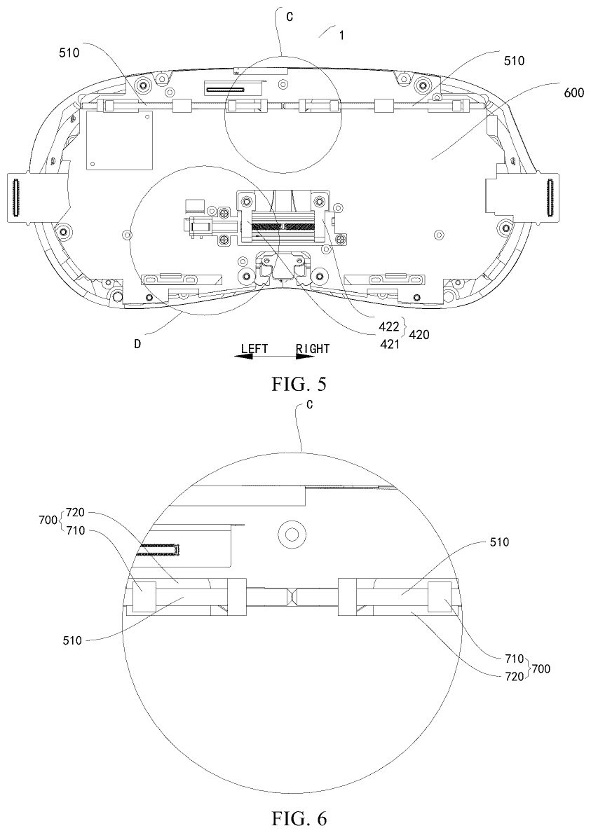

In some embodiments, as shown in FIGS. 5 and 6, the two moving members 420 are the first moving member 421 and the second moving member 422, respectively. The lead screw 430 is provided with two sections of threads on different sides of the lead screw 430, which are a left-handed external thread and a right-handed external thread, respectively. The first moving member 421 is provided with a left-hand internal thread to cooperate with the left-hand external thread on the lead screw 430. The second moving member 422 is provided with a right-handed internal thread to cooperate with a right-handed external thread on the lead screw 430.

When the lead screw 430 rotates clockwise, the first moving member 421 and the second moving member 422 move in opposite directions, and the two supporting members 310 move towards each other to reduce the distance between the two lenses 320. When the lead screw 430 rotates counterclockwise, the first and second moving members 421 and 422 move away from each other, and the two supporting member 310 move away from each other to increase the distance between the two lenses 320.

According to some optional embodiments of the present application, the rotation axis of the driving motor coincides with the rotation axis of the lead screw 430, so as to ensure that the lead screw 430 can be driven to rotate in the same direction when the driving motor rotates, and further ensure that the driving motor can drive two moving members 420 to move away from or towards each other when the driving motor rotates, while saving space.

Further, the driving motor is directly connected to the lead screw 430 to drive the lead screw 430 to rotate, so that the drive mode is simple, space saving and the weight of the head-mounted electronic device 1 can be reduced.

According to some optional embodiments of the present application, the head-mounted electronic device 1 further comprises a fixing member 600 which is fixed to the housing 100. The driving member 410 is fixed to the fixing member 600 to drive the moving member 420 to move relative to the housing 100 by the driving member 410.

Specifically, when the user uses the head-mounted electronic device 1, the position of the human eye does not move relative to the housing 100, that is, it does not move relative to the fixed member 600 and the driving member 410. When the driving member 410 drives the moving member 420 to move, the moving member 420 drives the supporting member 310 and the lens 320 to move relative to the driving member 410, that is, relative to the fixed member 600, the housing 100 and the human eye. When the lenses 320 move towards or away from each other, the position of the lenses 320 relative to the human eye changes to adapt to the position of the user's human eye, so that the distance between the two lenses 320 matches the distance between the human eyes.

According to some specific embodiments of the present application, the limiting member comprises a guide shaft 510 fixed on the fixing member 600. Each supporting member 310 is provided with a mating hole 311. The guide shaft 510 passes through the mating hole 311 and the mating hole 311 movably cooperates with the guide shaft 510. That is, the guide shaft 510 passes through the mating hole 311 on the supporting member 310 to cooperate the supporting member 310 with the fixing member 600 to avoid rotation of the supporting member 310.

Specifically, the supporting member 310 is fixed to the moving member 420, and the guide shaft 510 limits the rotation of the moving member 420 while limiting the rotation of the supporting member 310. In other words, when the driving member 410 drives the lead screw 430 to rotate, it is possible to prevent the moving member 420 from rotating with the lead screw 430, so as to convert the rotation of the lead screw 430 into the movement of the moving member 420, and drive the supporting member 310 and the lens 320 to move by the moving member 420.

In some embodiments, as shown in FIG. 5, the fixing member 600 is provided with two guide shafts 510 thereon. The two guide shafts 510 are arranged on the fixing member 600 in the left-right direction, and the axial directions of the two guide shafts 510 are on a straight line and extend in the left-right direction. The two supporting members 310 are arranged at intervals in the left-right direction. Each supporting member 310 is provided with a plurality of mating holes 311 on the side facing the fixed member 600, so that each supporting member 310 can be more stably matched with the corresponding guide shaft 510.

When the supporting member 310 moves with the moving member 420, the mating hole 311 moves in the left-right direction on the guide shaft 510 to limit the supporting member 310 to move only in the left-right direction. For example, the left supporting member 310 drives the corresponding lens 320 to move to the right, and the right supporting member 310 drives the corresponding lens 320 to move to the left. At this time, the distance between the two lenses 320 becomes smaller. The left supporting member 310 drives the corresponding lens 320 to move to the left, and the right supporting member 310 drives the corresponding lens 320 to move to the right. At this time, the distance between the two lenses 320 becomes larger. (The left and right directions are shown in FIG. 5. It needs to be understood here that the above direction limitation is only for the convenience of describing the accompanying drawings, and will not limit the actual setting position and direction of the head-mounted electronic device 1).

The distance between the two lenses 320 in the left-right direction is adjusted by limiting the movement of the supporting member 310 in the left-right direction so that the distance between the two lenses 320 can be adapted to the user's pupillary distance, thereby facilitating the user to view the contents on the screen 340 more clearly.

According to some specific embodiments of the present application, the head-mounted electronic device 1 further comprises a limiting apparatus 700 comprising a bypass channel 720 disposed on the fixing member 600 and a mating protrusion 710 disposed on the supporting member 310. The mating hole 311 is provided within the mating protrusion 710. The mating protrusion 710 movably cooperates with the bypass channel 720. The length of the bypass channel 720 defines the moving range of the fitting protrusion 710 to define the moving range of the moving member 320, thereby avoiding excessive moving range of the moving member 320 and avoiding the distance between the two moving members 320 being too large or too small.

In particular, by providing the bypass channel 720, the moving range of the moving member 320 can be limited, and then the movable range of the supporting member 310 can be limited. This can avoid the moving distance of the moving member 320 being too large, avoid the distance between the two supporting members 310 being too large, and affect the subsequent adjustment of the distance between the two lenses 320; it can also avoid the distance between the two supporting members 310 being too small, which may cause the left display unit 301 and the right display unit 302 to collide, and cause damage, such as scratches, to the left display unit 301 and the right display unit 302.

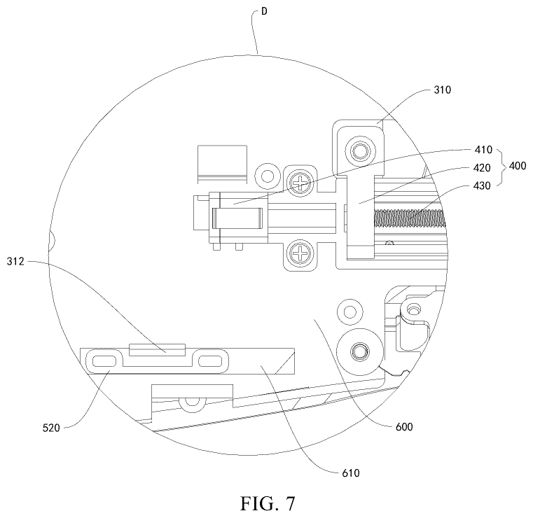

In some embodiments, as shown in FIGS. 6 and 7, two bypass channels 720 are provided on the left and right sides of the fixing member 600, respectively corresponding to the mating protrusions 710 on the two supporting members 310. The length direction of the bypass channel 720 extends in the left-right direction, and at least a part of the mating protrusion 710 is arranged in the bypass channel 720 to slidably cooperate with the bypass channel 720. When the driving member 410 drives the moving member 420 to move away from each other, the left mating protrusion 710 moves leftwards, and at most can move to the leftmost end of the corresponding bypass channel 720, the right mating protrusion 710 moves rightwards and at most moves to the rightmost end of the corresponding bypass channel 720. At this time, the distance between the two lenses 320 is the maximum value, and the moving members 420 cannot continue to drive the two lenses 320 to continue moving away from each other.

When the driving member 410 drives the moving member 420 to move towards each other, the left mating protrusion 710 moves rightwards and at most moves to the rightmost end of the corresponding bypass channel 720, and the right mating protrusion 710 moves leftwards and at most moves to the leftmost end of the corresponding bypass channel 720. At this time, the distance between the two lenses 320 is the minimum value, and the moving members 420 cannot continue to drive the two lenses 320 to move towards each other.

According to some optional embodiments of the present application, a moving channel 610 is provided on the fixing member 600, and the limiting member includes a sliding protrusion 520 provided on the supporting member 310. The sliding protrusion 520 movably cooperates with the inner wall of the moving channel 610 to limit the movement direction of the supporting member 310 by limiting the movement of the sliding protrusion 520.

Specifically, the sliding protrusion 520 on the supporting member 310 cooperates with the moving channel 610 on the fixing member 600. The supporting member 310 moves along the moving channel 610 relative to the fixing member 600 when the sliding protrusion 520 moves within the moving channel 610.

In some embodiments, as shown in FIGS. 5 and 7, the length direction of the moving channel 610 extends in the left-right direction, and two moving channel 610 are provided on the fixing member 600, the two moving channel 610 are provided in the left-right directions at intervals. Each moving channel 610 cooperates with the sliding protrusion 520 on one support member 310. When the driving member 410 drives the moving member 420 to move in the left-right direction, the moving member 420 may drive the sliding protrusion 520 on the supporting member 310 to move in the left-right direction within the moving channel 610 to change the distance between the two supporting members 310 and thus the distance between the two lenses 320.

According to some specific embodiments of the present application, a buckle member 312 is provided on the supporting member 310. The buckle member 312 protrudes from the moving channel 610 and hooks to the wall surface of the fixing member 600 so that the supporting member 310 can stably move relative to the fixing member 600, preventing the supporting member 310 from falling off from the fixing member 600.

Specifically, the buckle member 312 hooks the wall surface of the fixing member 600, which can make the supporting member 310 and the fixed member 600 cooperate more stably. When the supporting member 310 moves, the buckle member 312 can move within the moving channel 610 in the same direction as the movement of the supporting member 310, avoiding interfering with the movement of the supporting member 310 and the lens 320. According to some embodiments of the present application, the driving apparatus 400 further comprises a reducer. An input end of the reducer is connected to the driving motor, an output end of the reducer is connected to the lead screw 430. The reducer is capable of adjusting the rotational speed of the lead screw 430 to adjust the moving speed of the moving member 420, and thereby adjusting the moving speed of the supporting member 310 and the lens 320.

In particular, the reducer may be a gear reducer or a worm gear reducer to adjust the rotational speed of the driving motor output to the lead screw 430. It can also be used to adjust the moving speed of the two moving members 420 moving towards or away from each other. This can avoid that the moving member 420 from moving the supporting member 310 and the lens 320 too fast or too slow, which will affect the accuracy of the adjustment when adjusting the distance between the two lenses 320.

It should be noted that the structure of the driving apparatus 400 is not limited to this as long as the two supporting members 310 can be driven to move, for example, the driving apparatus 400 can include a gear train and a rack that meshes with the gear train. Each moving member 420 has a rack. The moving member 420 is driven to move by the rack.

In the description of the present application, it is to be understood that the terms “center”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential” and the like are indicative of the azimuthal or positional relationships based on those shown in the accompanying drawings for the purpose of describing the present application and the simplified description only, and not indicating or implying that the device or element referred to must have a particular orientation, construction and operation in a particular orientation, and therefore cannot be construed as a limitation of the present application. Furthermore, features defined as “first” and “second” may explicitly or implicitly include one or more of the features. In the description of the present application, unless otherwise stated, “multiple” means two or more. In the description of the present application, the first feature being “above” or “below” the second feature may include the first and second features being in direct contact, or may include the first and second features not being in direct contact but being in contact through another feature therebetween.

In the description of the present application, the first feature being “above”, “on” and “over” the second feature includes the first feature being directly above and diagonally above the second feature, or simply means that the first feature is higher in horizontal height than the second feature.

In the description of the present application, it is to be noted that, unless otherwise expressly specified and defined, the terms “installation”, “communication”, “connection”, “cooperation” are to be understood in a broad sense. For example, they may be fixed connections, detachable connections, or integrated connections; they can be mechanical connections or electrical connections; they can be direct connection or indirect connection through an intermediate medium, and they can be internal communications between two components; they can be direct or indirect cooperation through an intermediate medium. For those of ordinary skill in the art, the above terms can be specifically understood in the present application.

In the description of this specification, reference to the description of the terms “one embodiment”, “some embodiments”, “illustrative embodiments”, “example”, “specific example”, or “some examples” refer to specific features, structures, materials, or features described in conjunction with embodiments or examples are included in at least one embodiment or example of the present application. In this specification, the illustrative expressions of the above terms do not necessarily refer to the same embodiment or example. Moreover, the described specific features, structures, materials or features can be appropriately combined in any one or more embodiments or examples.

Although embodiments of the present application have been shown and described, those skilled in the art can understand that various changes, modifications, substitutions and variations can be made to these embodiments without departing from the principles and purposes of the present application, and the scope of the present application is defined by claims and equivalents thereof.

1. A head-mounted electronic device, comprising:
a housing in which a controller is provided;
an obtaining unit for obtaining human eye positions, the obtaining unit being provided in the housing, and the obtaining unit being connected to the controller;
a left display unit and a right display unit, each of the left display unit and the right display unit comprising a lens and a supporting member, the lens being fixed to the supporting member;
a driving apparatus comprising a driving member and two moving members, the driving member cooperating with the two moving members to drive the two moving members to move, the two moving members cooperating with the two supporting members respectively to drive the two supporting members to move away from or towards each other, the driving member being connected to the controller, and the controller controlling the driving member to drive the two moving members to move according to information obtained by the obtaining unit to adjust a distance between the two lenses.

2. The head-mounted electronic device of claim 1, wherein the obtaining unit is a camera.

3. The head-mounted electronic device of claim 1, wherein the moving member and the supporting member are detachably mated.

4. The head-mounted electronic device of claim 1, wherein each of the display units further comprises a barrel and a screen, each of the lenses is provided on the barrel, the barrel is fixed on the supporting member, and the screen is provided between each of the barrels and the corresponding supporting member.

5. The head-mounted electronic device of claim 1, further comprising a limiting apparatus cooperating with the moving member and the housing to limit a moving range of the moving member.

6. The head-mounted electronic device of claim 1, wherein the driving member is a driving motor, the driving apparatus further comprises a lead screw, the driving motor cooperates with the lead screw to drive the lead screw to rotate, the lead screw is provided with double-helical external threads, and the two moving members cooperate with the threads of the lead screw respectively;
the head-mounted electronic device further comprises a limiting member for limiting rotational freedom of the moving member.

7. The head-mounted electronic device of claim 6, further comprising a fixing member fixed to the housing, and the driving member being fixed to the fixing member.

8. The head-mounted electronic device of claim 7, wherein the limiting member comprises a guide shaft fixed to the fixing member, each of the supporting members is provided with a mating hole, the guide shaft passes through the mating hole and the mating hole movably cooperates with the guide shaft.

9. The head-mounted electronic device of claim 8, further comprising a limiting apparatus comprising a bypass channel provided on the fixing member and a matching protrusion provided on the supporting member, the mating hole being provided within the mating protrusion, the mating protrusion movably cooperating with the bypass channel, and a length of the bypass channel defining a moving range of the mating protrusion to define a moving range of the moving member.

10. The head-mounted electronic device of claim 7, wherein the fixing member is provided with a moving channel thereon, the limiting member comprises a sliding protrusion provided on the supporting member, and the sliding protrusion movably cooperates with an inner wall of the moving channel.

11. The head-mounted electronic device of claim 10, wherein the supporting member is provided with a buckle member thereon, the buckle member protrudes out of the moving channel and hooks to a wall surface of the fixing member.

12. The head-mounted electronic device of claim 6, wherein a rotation axis of the driving motor coincides with a rotation axis of the lead screw.

13. The head-mounted electronic device of claim 6, wherein the driving apparatus further comprises a reducer, an input end of the reducer is connected to the driving motor, and an output end of the reducer is connected to the lead screw.
